(19) United States
(12) Patent Application Publication
(10) Pub. No.: US 2016/0111914 A1
(43) Pub. Date: Apr. 21, 2016

(54) MULTI-VOLTAGE EXTENDED OPERATION DC POWER SUPPLY SYSTEM

(71) Applicants: Hugh C. Willard, Raleigh, NC (US); Michael R. Willard, Charlotte, NC (US)

(72) Inventors: Hugh C. Willard, Raleigh, NC (US); Michael R. Willard, Charlotte, NC (US)

(21) Appl. No.: 14/515,478

(22) Filed: Oct. 15, 2014

(51) Int. Cl. H02J 9/06; H02J 7/00

(52) U.S. Cl. CPC H02J 9/061; H02J 7/0068; H02J 7/0077; H02J 7/0047; H02J 2007/0049; H02J 2007/005

(57) ABSTRACT

A multi-voltage direct current uninterruptable power supply (DC-UPS) system is described, which is configured to receive electrical energy from any of a plurality of sources external to the system, process such energy into a particular format, store the formatted energy, and convert the stored energy into multiple, adjustable, simultaneous, continuous direct current and desired voltage streams. The DC UPS system is configured to combine particular streams to implement load sharing, and to deliver these current streams to a plurality of external devices by a plurality of interconnections. In various implementations, the system may be configured to monitor and report state of charge (SOC) levels, processor activity, and other operational variables. In embodiments, the system may be configured with a single main board capable of routing the various voltage and current streams with substantial configuration flexibility, and of providing synthesized regulated voltages in a highly efficient manner.

### FIELD

The present disclosure relates to a long-cycle multi-simultaneous and continuous multi-voltage Direct Current Uninterruptible Power Supply (DC-UPS) apparatus including multiple-source-types of charging inputs to internal and/or external battery/batteries, multiple-voltage and multiple-connector type outputs to supported devices. The DC-UPS apparatus provides continuous output service for multiple device charging and multiple device powering, comprising electrical circuits for supplying multiple continuous operating voltages and currents and multiple continuous charging voltages and currents. The disclosure contemplates a variety of associated methods and embodiments of the DC-UPS apparatus, to control, monitor and deliver these voltages and currents in an environment of unreliable and intermittent mains and/or an environment requiring an alternative source of continuous electrical energy.

### BACKGROUND OF RELATED ART

In the use of wired Internet communications equipment, power for individual elements of a local network may fail, due to loss or interruption of the mains supply or for other reasons, e.g., for short periods of up to 5 seconds as transients that can disrupt and stop operations of communications devices, or for midrange periods of up to a few minutes, or for long periods of time measured in hours to days.

The outcomes of these failure events for the user of the communications equipment may vary from loss of local lighting, auto-rebooting of LAN-based equipment (including Internet and VOID modems, switches, routers, tablet computers, cordless telephones, etc.) with temporary loss of user data, to complete loss of function for periods of minutes to days. These failure events thus produce frustration, inefficiency and loss of communications benefits from inoperative equipment, as well as other negative results attendant to the loss of communications capability.

Currently available solutions for the power-outage issue include AC uninterruptible power supplies (UPSs), which operate by recognizing a power interruption event, and responsively generating a substitute AC voltage stream, using a small trickle-charged internal battery as a source of energy, and a DC-To-AC inverter. Some time passes before AC power resumes from the AC UPS following the power-outage event, usually in milliseconds for good products. The market generally finds this performance to be acceptable for transient protection. Commercially available AC UPS units typically provide from about 5 minutes to 30 minutes of run-time (i.e., duration of supplying electrical power) to the devices that are served by the AC UPS unit. Laptops, tablets and modern cellphones are all battery-operated and immune to the transient issue, but they are not immune to the longer-term outages because of the need to recharge their rechargeable batteries. Thus, conventional AC UPS units can provide protection against transients, but they cannot provide protection against power outages lasting longer than 5-30 minutes, depending on the specific AC UPS unit that is employed.

Internet service interruptions resulting from power outages are particularly problematic, and improvements in outage response time and in run-time after mains failure could significantly increase the value of Internet service to users. When utilizing conventional AC UPS units to address power outages, run-time is substantially constrained by small energy storage capacity and usage inefficiencies associated with double conversion energy losses (DC-to-AC-to-DC).

Concerning Internet service, it is to be recognized that most wired Internet services are obtained from service providers who power subscriber lines from a central power supply. As a result of such service provider architecture, Internet signal remains available, and local power outages, whether short or longer in duration, do not result in actual loss of the Internet signal. Instead, the still-available Internet signal simply cannot be distributed and processed locally, due to the local disruption of mains powering of the equipment constituting the local network.

It therefore would be a significant advance in the art to provide an uninterruptible power supply that is responsive to transient as well as extended duration power interruptions, and that can provide continuous, stable electrical power for sustained periods of time that are of far greater duration than is currently available from conventional commercial UPS units, which can provide multiple operating voltages and currents to power multiple electrically-powered devices, such as cell phones, tablets, laptops, and other electrical appliances.

### SUMMARY

The present disclosure generally relates to multi-voltage direct current uninterruptable power supply apparatus, sub-assemblies, and methods of making and using same. More specifically, the disclosure relates to extended duration multi-simultaneous and continuous multi-voltage direct current uninterruptible power supply (DC-UPS) apparatus including multiple-source-types of charging inputs to internal and/or external battery energy storage components, and multiple-voltage and multiple-connector type outputs to supported devices, comprising electrical circuits for supplying multiple continuous operating voltages and currents and multiple continuous charging voltages and currents. The disclosure further contemplates subassemblies and components of such apparatus, and related methodology for generating, controlling, monitoring, and delivering multiple continuous operating voltages and currents of multiple continuous charging voltages and currents, e.g., in environments of unreliable and intermittent mains and/or environments requiring alternative stable continuous sources of electrical power for device and infrastructure operation.

In one aspect, the present disclosure relates to a multi-voltage direct current uninterruptable power supply, comprising:

an input power conditioner assembly comprising an AC-to-DC converter adapted to receive power continuously from an AC power source and responsively generate a DC output;
a rechargeable battery arranged to receive the DC output of the input power conditioning assembly, and to provide continuous output power; and
a power management assembly comprising:
a power management circuit arranged to receive output power from the rechargeable battery, the power management circuit comprising a line fuse, a field effect transistor switch, and a DC input power rail, arranged so that when the field effect transistor switch is actuated, power is delivered continuously from the rechargeable battery through the line fuse and field effect transistor switch of the power management circuit to the DC input power rail at a rate correlative to aggregate load on the rail, the power management circuit further comprising a boost regulator coupled with the field effect transistor switch, with a current-limiting resistor therebetween;
a power-on switch actuatable to generate an initiating output signal for transmission in the power management circuit to the boost regulator, with the boost regulator being responsive to the initiating output signal to transmit a positive bias voltage in the power management circuit through the current-limiting resistor to the field effect transistor switch so that the field effect transistor switch is actuated to enable power delivery from the rechargeable battery through the line fuse to the DC input power rail, and to provide a latch for the positive bias voltage to the field effect transistor switch; and
a momentary switch actuatable to ground the positive bias voltage and thereby deactuate the field effect transistor switch and terminate power delivery from the rechargeable battery through the line fuse to the DC input power rail.

In another aspect, the disclosure relates to a direct current uninterruptible power supply apparatus, comprising power input circuitry for receiving power effective for charging a rechargeable battery, a rechargeable battery coupled with said power input circuitry for charging thereof, a DC input power rail coupled with the rechargeable battery, and DC output power circuitry coupled with the DC input power rail and with multiple DC power output ports, said DC output power circuitry comprising a plurality of buck DC-DC converters and routing switches configured to deliver DC output power at different voltages to at least some of the multiple DC power output ports, and configured to vary currents of the DC output power delivered to the multiple DC power output ports in response to charging or operating loads of devices coupled thereto, to thereby effect load sharing between the ones of the multiple DC power output ports to which devices are coupled.

In one aspect, the disclosure relates to a method of maintaining continued operational viability of at least one electrically powered device during a local electrical network outage, such method comprising transmitting charging and/or operating power to the at least one electrically powered device while coupled to a direct current uninterruptible power supply of the present disclosure.

Other aspects, features and embodiments of the disclosure will be more fully apparent from the ensuing description and appended claims.

### BRIEF DESCRIPTION OF THE DRAWINGS

FIG. 1 is a front perspective view of a multi-voltage extended operation DC power supply module, according to one embodiment of the disclosure.

FIG. 2 is a rear perspective view of the multi-voltage extended operation DC power supply module of FIG. 1.

FIG. 3 is a front elevation view of the multi-voltage extended operation DC power supply module of FIG. 1.

FIG. 4 is a rear elevation view of the multi-voltage extended operation DC power supply module of FIG. 1.

FIG. 5 is a top plan view of the multi-voltage extended operation DC power supply module of FIG. 1.

FIG. 6 is a bottom plan view of the multi-voltage extended operation DC power supply module of FIG. 1.

FIG. 7 is a left-hand elevation view of the multi-voltage extended operation DC power supply module of FIG. 1.

FIG. 8 is a right-hand elevation view of the multi-voltage extended operation DC power supply module of FIG. 1.

FIG. 9 is an exploded front perspective view of the multi-voltage extended operation DC power supply module of FIGS. 1-8, showing the details of construction thereof.

FIG. 10 is an exploded rear perspective view of the multi-voltage extended operation DC power supply module of FIGS. 1-8, showing the details of construction thereof.

FIG. 11 is a front perspective view of a multi-voltage extended operation DC power supply system according to one embodiment of the present disclosure, comprising a multi-voltage extended operation DC power supply module of a type as shown in FIGS. 1-10, operatively coupled to an energy source assembly, and operatively coupled to electrically powered devices receiving power from the DC power supply module.

FIG. 12, comprising FIGS. 12A, 12B, 12C, and 12D, is a schematic circuit diagram for the electrical circuitry of the multi-voltage extended operation DC power supply system, according to one embodiment of the disclosure.

FIG. 13, comprising FIGS. 13A and 13B, is a schematic circuit diagram for the electrical circuitry for internal controls in the multi-voltage extended operation DC power supply system.

FIG. 14 is a schematic diagram of a battery energy input source assembly coupled by a cable arrangement with the multi-voltage extended operation DC power supply module.

FIG. 15 is a schematic representation of a USB header of the multi-voltage extended operation DC power supply module.

FIG. 16 is a schematic diagram of the electrical circuitry for the charge module on the printed circuit board of the multi-voltage extended operation DC power supply module.

FIG. 17 is a schematic diagram of the charge module connection to the energy source assembly.

FIG. 18 is a schematic representation of the sockets and selectors of the multi-voltage extended operation DC power supply system.

FIG. 19, comprising FIGS. 19A, 19B, 19C, and 19D, is a schematic representation of the printed circuit board arrangement and components, in a multi-voltage extended operation DC power supply module, according to one embodiment of the disclosure.

### DETAILED DESCRIPTION

The present disclosure relates to an extended operation multi-simultaneous and continuous multi-voltage direct current uninterruptible power supply (DC-UPS) apparatus and associated subassemblies and components and methodology.

The present disclosure contemplates a multi-voltage extended operation DC power supply system comprising a multi-voltage extended operation DC power supply module adapted for connection to an energy source assembly so that the module receives energy and processes such energy for storage and subsequent supply of multiple simultaneous continuous direct-current in desired streams to multiple external devices via power delivery coupling of the external devices to DC power supply ports of the module.

The DC-UPS apparatus of the present disclosure seamlessly prevents interruption and loss of Internet, security, and other electrical services that would otherwise occur due to loss of local mains power, by providing no-startup, flicker-free DC power to electrical devices connected to such apparatus, before, during, and after mains disruption. The DC-UPS apparatus is advantageously configured with a battery-in-the-middle architecture, as hereinafter more fully described, which provides an extraordinarily high level of protection against transients, with substantially more energy storage capacity and efficiency than conventional AC-UPS units.

Additionally, the DC-UPS apparatus of the present disclosure avoids an entire cycle of conversion losses, in relation to DC-to-AC-to-DC conversions associated with conventional AC-UPS units. Direct current is directly delivered by the DC-UPS apparatus of the present disclosure to the electrically-powered devices coupled to and served by the DC-UPS apparatus, thereby avoiding the mains interruption recognition processing that is employed in conventional AC-UPS units.

The full-time-powering, no-startup architecture of the DC-UPS apparatus of the present disclosure, providing a multi-simultaneous-and-continuous voltage DC uninterruptible power supply (DC-UPS), is a fundamental advance in the UPS art, in relation to conventional AC-UPS and DC-UPS approaches.

At no time during the occurrence of a mains interruption event while using the DC-UPS apparatus of the present disclosure, does the voltage delivered to the served devices coupled to the apparatus vary from its assigned DC range by more than a few percent, so long as the battery of the DC-UPS apparatus is charged. This is correspondingly true for all functions provided by the DC-UPS apparatus, including for example mobile device charging, emergency lighting, and continuous powering of monitoring and security systems. In addition, run-time can be extended to almost arbitrary lengths, e.g., days, weeks, and months, by the simple expedient of combining and cascading storage capacity associated with the DC-UPS system of the present disclosure.

In one aspect, the present disclosure relates to a multi-voltage direct current uninterruptable power supply, comprising:

an input power conditioner assembly comprising an AC-to-DC converter adapted to receive power continuously from an AC power source and responsively generate a DC output;
a rechargeable battery arranged to receive the DC output of the input power conditioning assembly, and to provide continuous output power; and
a power management assembly comprising:
a power management circuit arranged to receive output power from the rechargeable battery, the power management circuit comprising a line fuse, a field effect transistor switch, and a DC input power rail, arranged so that when the field effect transistor switch is actuated, power is delivered continuously from the rechargeable battery through the line fuse and field effect transistor switch of the power management circuit to the DC input power rail at a rate correlative to aggregate load on the rail, the power management circuit further comprising a boost regulator coupled with the field effect transistor switch, with a current-limiting resistor therebetween;
a power-on switch actuatable to generate an initiating output signal for transmission in the power management circuit to the boost regulator, with the boost regulator being responsive to the initiating output signal to transmit a positive bias voltage in the power management circuit through the current-limiting resistor to the field effect transistor switch so that the field effect transistor switch is actuated to enable power delivery from the rechargeable battery through the line fuse to the DC input power rail, and to provide a latch for the positive bias voltage to the field effect transistor switch; and
a momentary switch actuatable to ground the positive bias voltage and thereby deactuate the field effect transistor switch and terminate power delivery from the rechargeable battery through the line fuse to the DC input power rail.

The above-described multi-voltage direct current uninterruptable power supply may be configured to include monitoring circuitry that is operative to provide at least one of (i) output indicative of state of charge of the rechargeable battery, (ii) actuation of the momentary switch for shutdown of the multi-voltage direct current uninterruptable power supply corresponding to a predetermined state of charge condition of the rechargeable battery, and (iii) output indicative of an approaching state of charge condition for actuation of the momentary switch for shutdown of the multi-voltage direct current uninterruptable power supply.

For example, the monitoring circuitry may comprise an output device, such as a visual output display, e.g., an LED output display, and/or an audible alarm.

In specific embodiments, the multi-voltage direct current uninterruptible power supply may include monitoring circuitry that is configured to monitor the rechargeable battery and to provide an output indicative of battery charge. For example, the monitoring circuitry may comprise at least one LED that is actuated to provide the output indicative of battery charge, as for example a first LED that is actuated to provide a low battery charge indication, and a second LED that is actuated to provide a full battery charge indication.

In other embodiments, the multi-voltage DC-UPS may comprise monitoring circuitry that is configured to monitor the rechargeable battery and to provide an output indicative of imminent shutdown due to depletion of battery charge of the rechargeable battery. The output can be of any suitable type, and can include an acoustic output and/or a visual output. In still other embodiments, the monitoring circuitry may be configured to terminate operation of the power supply when battery charge has declined to a predetermined charge level.

In various implementations, the multi-voltage DC-UPS includes a plurality of DC power delivery circuits coupled to the DC input power rail and configured to provide DC output power, with at least one DC power output port coupled to each of the plurality of DC power delivery circuits. In such arrangements, each DC power output port may be configured to provide a DC power output at a voltage that is different from at least one other DC power output port. The multi-voltage DC-UPS may be constituted in specific embodiments so that each DC power output port is configured to provide a different DC power output.

In an illustrative embodiment, the multi-voltage DC-UPS may include at least six DC power output ports, e.g., wherein such ports include at least one USB port, and advantageously a multiplicity of USB ports.

The multi-voltage DC-UPS may be constituted to include one or more buck DC-DC converters, each configured to receive DC power from the DC input power rail through a selector switch and to deliver a reduced voltage output to a second selector switch bank for routing to deliver DC output power.

In various arrangements, the multi-voltage DC-UPS may comprise one or more buck DC-DC converters, each of which is connected to a routing switch bank and steering diodes to deliver DC output power. In various arrangements, the multi-voltage DC-UPS may comprise multiple buck DC-DC converters connected to circuitry defining a plurality of DC output power routes, wherein each of the multiple buck DC-DC converters is adjustable and wherein the circuitry is configured to operatively adjust the multiple buck DC-DC converters or a selected one or ones thereof to provide predetermined current(s) to a selected one or ones of the plurality of DC output power routes. In various arrangements, the multi-voltage DC-UPS can include adjustable analog buck DC-DC converters connected via selector switches to provide a selectable and routable DC output power.

The multi-voltage DC-UPS in various embodiments may include first and second switch banks, wherein the second switch bank receives power from the first switch bank and is configured to enable selection of specific ones of multiple routes for delivery of DC output power to specific ones of multiple DC output power ports.

The multi-voltage DC-UPS may generally include one or more USB sockets configured to deliver charging and powering DC output power.

In various embodiments, the multi-voltage DC-UPS can include circuitry coupled to the DC input power rail and to multiple cylindrical sockets, wherein the circuitry is configured to deliver differing DC output voltages to at least some of the multiple cylindrical sockets. For example, the circuitry may be configured to deliver a different DC output voltage to each of the multiple cylindrical sockets. Each of the multiple cylindrical sockets may be color-coded to specify the differing DC output voltages thereof. Such a color-coded DC-UPS may be provided in combination with DC output power delivery cables that are configured to be coupled with corresponding ones of the multiple cylindrical sockets, and color-coded in correspondence thereto.

The multi-voltage DC-UPS in various embodiments may be constructed and arranged with the power management circuit being provided on a main printed circuit board that is mounted in a housing enclosure comprising a panel including DC output power ports that are coupled with the power management circuit and supply different voltages of DC output power.

The DC-UPS of the present disclosure may be constituted as a direct current uninterruptible power supply apparatus, comprising power input circuitry for receiving power effective for charging a rechargeable battery, a rechargeable battery coupled with said power input circuitry for charging thereof, a DC input power rail coupled with the rechargeable battery, and DC output power circuitry coupled with the DC input power rail and with multiple DC power output ports, said DC output power circuitry comprising a plurality of buck DC-DC converters and routing switches configured to deliver DC output power at different voltages to at least some of the multiple DC power output ports, and configured to vary currents of the DC output power delivered to the multiple DC power output ports in response to charging or operating loads of devices coupled thereto, to thereby effect load sharing between the ones of the multiple DC power output ports to which devices are coupled.

In such DC-UPS apparatus, the power input circuitry may comprise an AC-to-DC converter to accommodate AC power input to the apparatus from an external AC source.

Monitoring circuitry may be employed in such apparatus, as configured to monitor the charge state of the rechargeable battery and to generate an output correlative of the charge state, e.g., wherein the monitoring circuitry comprises at least one of an acoustic output device and a visual output device for transmitting set output correlative of the charge state, such as at least one LED visual output device.

The DC-UPS apparatus may include multiple DC power output ports that are color-coded to DC output power voltages delivered by such ports. The DC-UPS apparatus may be provided in combination with multiple DC power delivery cables that are color-coded to the DC power output ports to which they are intended to be coupled.

The rechargeable battery of the DC-UPS apparatus may comprise a sealed lead acid battery.

The multiple DC power output ports of the DC-UPS apparatus may comprise one or more USB ports, and may for example comprise USB ports and non-USB ports in specific embodiments.

In use, the DC-UPS apparatus may be provided in combination with multiple electronic devices each coupled to a separate one of the multiple DC power output ports.

In a further aspect, the disclosure relates to a method of maintaining continued operational viability of at least one electrically powered device during a local electrical network outage, such method comprising transmitting charging and/or operating power to the at least one electrically powered device while coupled to a direct current uninterruptible power supply of the present disclosure.

Considering the monitoring circuitry of the DC-UPS in further detail, it will be apparent from the preceding discussion that such monitoring circuitry can provide the output in any suitable output mode, e.g., in a visual output mode, in an audio output mode, in an audiovisual output mode, or as an output signal by wired or wireless transmission to a smartphone, tablet, personal digital assistant, laptop or desktop computer, or other display or output receiver.

In specific embodiments, the monitoring circuitry may include an LED display providing a visual output of a low battery condition, a fully charged battery condition, a state-of-charge regime (e.g., a red-yellow-green LED array corresponding to low-intermediate-high state-of-charge of the rechargeable battery), or other output condition. In other embodiments, the monitoring circuitry may comprise an audible alarm generator or synthesized speech generator warning of a low battery condition, an imminent shutdown condition, etc.

In various embodiments, the multi-simultaneous and continuous voltage DC-UPS comprises one or more input power conditioners, which may for example include an isolated AC to DC converter, producing a DC output voltage, and fitted with a complementary DC plug for delivering charging current to the energy storage battery of the DC-UPS apparatus. In other embodiments, the input power conditioner can utilize solar, wind, hydrothermal, and other energy sources. The DC-UPS apparatus may be configured to receive input power from any of a variety of energy sources, and can in various embodiments utilize multiple simultaneous, or multiple alternative, energy sources.

Although the DC-UPS has been described herein as comprising a rechargeable battery as an energy storage device to collect charge from the input power conditioner(s), it will be recognize that multiple rechargeable batteries and/or other energy storage devices may be employed.

In various embodiments, a sealed lead acid (SLA) battery is employed as a preferred energy storage device in the DC-UPS, and advantageously may be arranged to collect charge from an input power conditioner at a rate dependent on state of charge (SOC) of the battery, and subsequently to deliver full-time charging and powering from the battery through a line fuse, to an FET switch, and when the FET switch is activated, to a DC input power rail on the main board of the DC-UPS apparatus, at a rate dependent on the sum of all loads on that rail.

The DC-UPS apparatus may in various embodiments comprise a boost regulator that is activated by a momentary signal from a power ON switch, and configured to deliver a positive bias voltage through a current-limiting resistor to an FET switch, thereby turning on the FET switch to power up the DC input power rail and provide a latch for the bias voltage to the FET switch. A momentary contact ON/ON switch may be provided that, when pressed by a user, pulls to ground the bias voltage that keeps the FET switch on, and thus when pressed kills the FET bias and turns off the FET and thereby the DC supplied to the main board, shutting down the main board operations.

More generally, the DC-UPS apparatus may in various embodiments comprise any suitable circuitry and/or components, e.g., one or more compatible features selected from among the following: (1) a circuit that provides a visual LED low battery warning; (2) a circuit that provides a visual LED full battery indicator; (3) a circuit that provides an acoustic imminent shutdown warning; (4) a circuit that provides an automatic battery protection shutdown, i.e., activates the above-discussed “kill switch;” (5) a momentary-contact manual ON/ON switch that in one direction of movement activates a circuit that energizes the FET switch, thus activating the main board, and that in the reverse direction of movement activates the aforementioned kill switch, thereby de-activating the main board; (6) one or more adjustable buck DC-DC converters, each of which receives DC power upon manual connection from the rail through a selector switch, and delivers each particular voltage to a second selector switch bank, which routes each selected voltage downstream for further selection and processing; (7) one or more adjustable buck DC-DC convertors that are connected to routing-switch banks and steering diodes to enhance the flexibility of selecting from a very wide array of possible configurations, e.g., at optimum cost; (8) one or more adjustable buck DC-DC convertors that may be adjusted and connected to circuit elements such that, on demand, the sum of currents selectively combine their respective DC streams for the purpose and effect of efficiently and flexibly sharing loads among a plurality of sources as indicated by varying need for more or less current to a particular route; (9) one or more adjustable analog DC buck DC-DC converters connected by selector switches to provide a selectable and DC routable supply with lower noise levels, and additional alternative configurations; (10) a second switch bank, whose members receive power from members of the first bank, and whose purpose and effect is to enable the selection of multiple routing targets for delivering selected voltages to specific desired physical sockets; (11) one or more USB V2 sockets externally accessible for delivering charging and powering services to users; and (12) an array of one or more color-coded cylindrical sockets for delivering particular desired voltages to specific served devices by particular supplied extension cables of coordinated color code.

The disclosure in a specific aspect of the DC-UPS operation contemplates a method of automatic load-sharing, comprising pressing into service one or more lesser-loaded DC converters during the operation of the DC-UPS apparatus in accordance with a routing function that enables load-sharing and flexible use of unused socket resources. As indicated above, the DC-UPS apparatus may comprise one or more color-coded cylindrical sockets for delivering specific desired voltages to specific served devices by particular supplied extension cables of coordinated color codes, i.e., the cylindrical socket may be circumscribed by a ring of a specific color, to which a same colored extension cable corresponds, so that the cable is matched to the appropriate cylindrical socket. The DC-UPS apparatus may therefore be provided as part of a kit including the DC-UBS apparatus and a set of voltage output cables that are color-coded in correspondence to colors associated with various ones of the cylindrical sockets of the DC-UPS apparatus. The disclosure further contemplates the method of revising these codes and/or assignments of particular voltages to particular sockets.

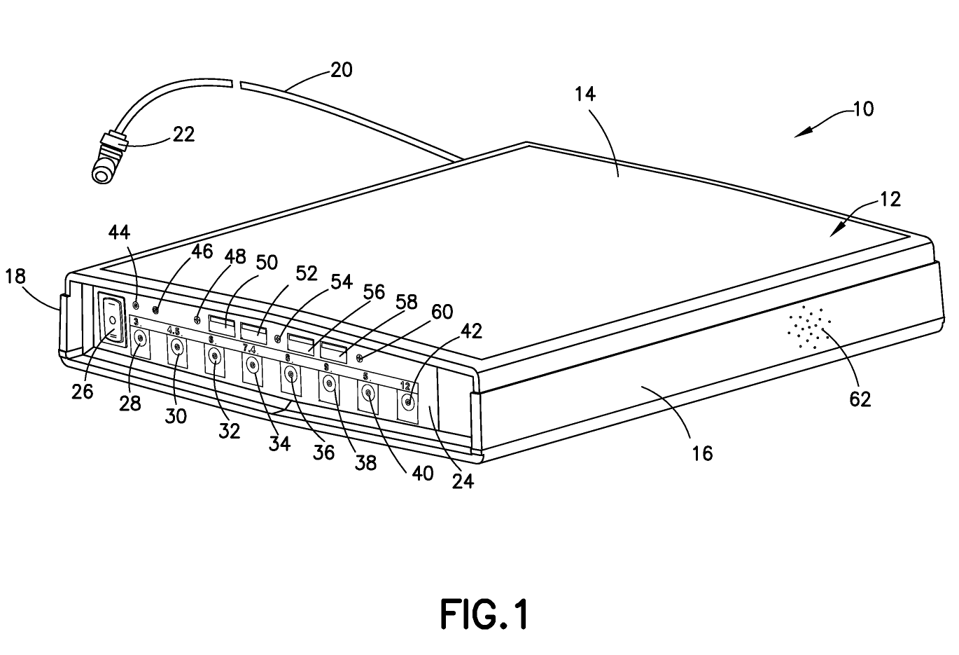

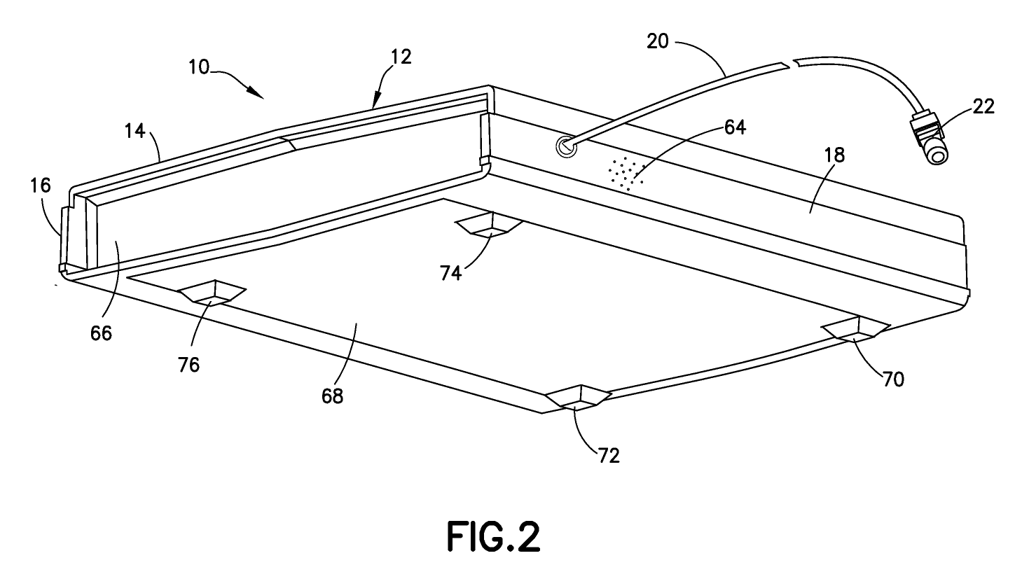

Referring now to the drawings, FIG. 1 is a front perspective view of a multi-voltage extended operation DC power supply module 10, according to one embodiment of the disclosure. FIG. 2 is a rear perspective view of the multi-voltage extended operation DC power supply module of FIG. 1, whose parts and components are numbered correspondingly with respect to the same features in FIG. 1.

The DC power supply module 10 includes a top cover 12 of inverted U shape to define a top panel 14, and side panels 16 and 18 depending downwardly from respective side edges of the top panel. The right-hand side panel 16 includes ventilation openings 62 at a rear portion thereof, and the left-hand side panel 18 in like manner includes ventilation openings 64 at a rear portion of such left-hand panel. The module includes a DC input cable 20 arranged with a distal end coupling 22 for interconnection with an external energy source assembly.

The external energy source assembly may be of any suitable type, and may include a solar energy assembly, a wind energy assembly, an alternating current source assembly, a battery such as a sealed lead acid battery or other energy supply assembly.

The DC power supply module 10 includes a front panel 24, as shown in FIG. 1, and a bottom cover 68 and a solid rear panel 66, as shown in FIG. 2, which together with the top cover 12 and front panel 24 define a housing of the module. The bottom cover is provided with foot support elements 70, 72, 74, and 76 at the corner regions of its lower surface. The foot support elements may be formed of rubber or other hard resilient shock-absorbing material.

The front panel 24 of the module, as shown in elevation view in FIG. 3, includes an on/off switch 26 for actuating or shutting off the module. A series of DC output ports are provided on the front panel 24. These include the multi-voltage female ports 28, 30, 32, 34, 36, 38, 40, and 42, which provide predetermined different DC output voltages at the respective ports, as supplied by the circuitry within the module housing, as hereinafter more fully described. In a specific embodiment, DC output voltage port 28 supplies a 3 V output, output voltage port 30 supplies a 4.5 V output, output voltage port 32 supplies a 6 V output, output voltage port 34 supplies a 7.4 V output, output voltage port 36 supplies an 8 V output, output voltage port 38 supplies a 9 V output, output voltage port 40 supplies a 5 V output, and output voltage port 42 supplies a 12 V output.

The front panel 24 also comprises DC output USB ports 50, 52, 56, and 58. An on/off indicator light 44 is provided adjacent the on/off switch 26 on the front panel, for visual feedback as to the operating state of the module, and a low battery indicator light 46 is provided adjacent the on/off indicator light 44, to provide an indication of when the DC output capability of the module has declined to a predetermined lower state, thereby providing the user with an indication of the onset of exhaustion of the module for power supply operation. The front panel 24 may be secured to the interior structure of the module by mechanical fasteners 48, 54, and 60, as shown in FIG. 3.

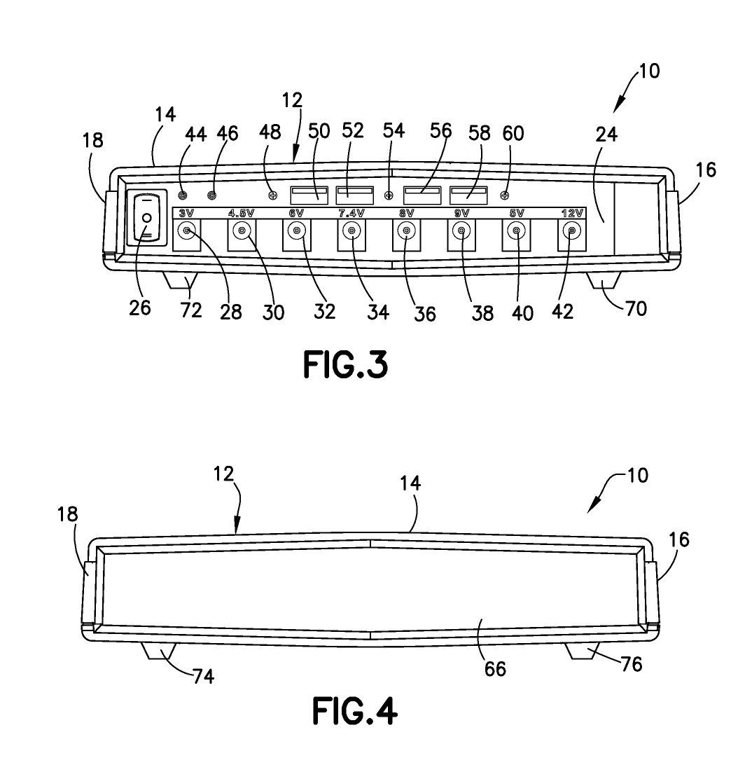

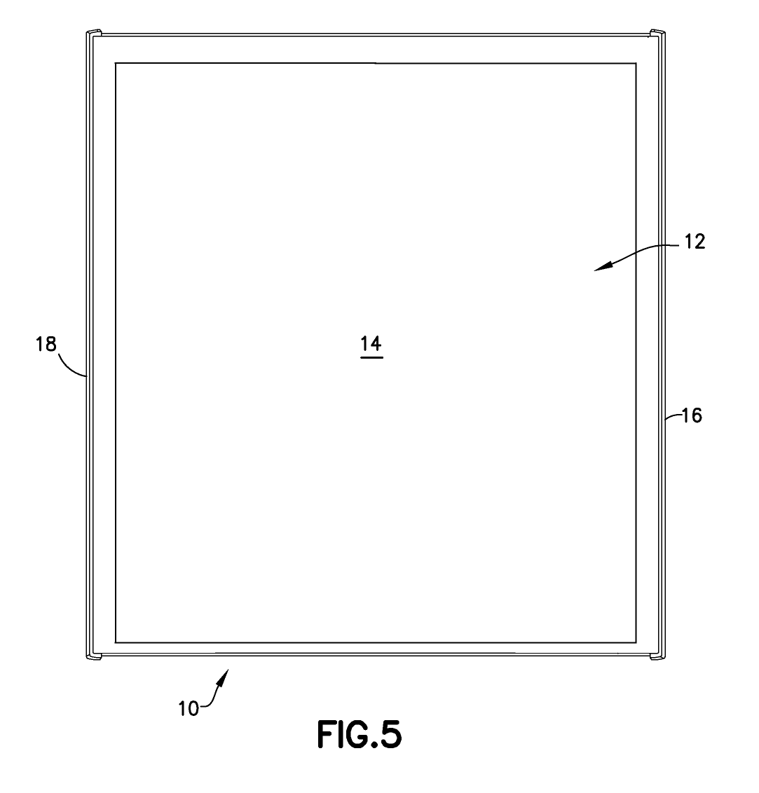

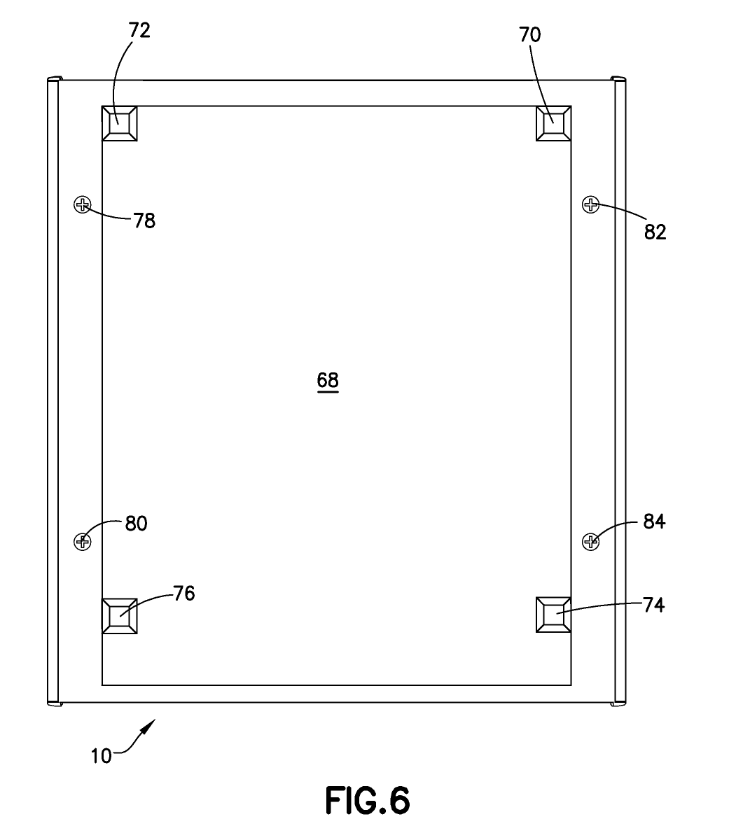

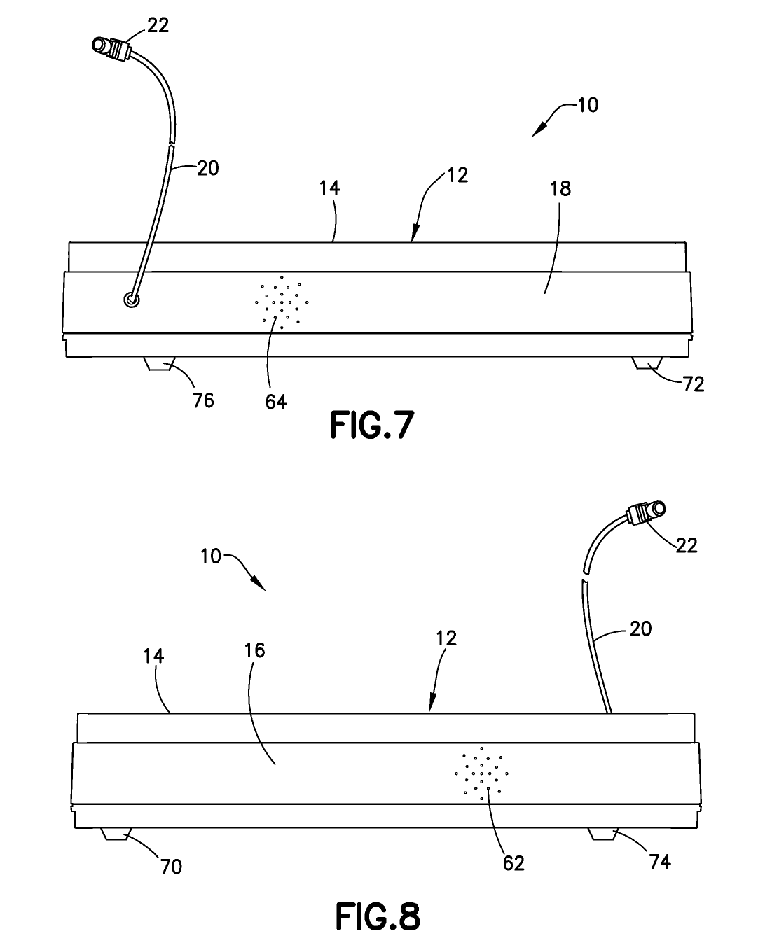

FIG. 4 is a rear elevation view of the multi-voltage extended operation DC power supply module of FIG. 1, FIG. 5 is a top plan view of the module, FIG. 6 is a bottom plan view of the module, FIG. 7 is a left-hand elevation view of the module, and FIG. 8 is a right-hand elevation view of the module, in which all parts and components are correspondingly numbered. As illustrated, the bottom cover 68 may be secured to the internal structure of the module by mechanical fasteners 78, 80, 82, and 84 (see FIG. 6).

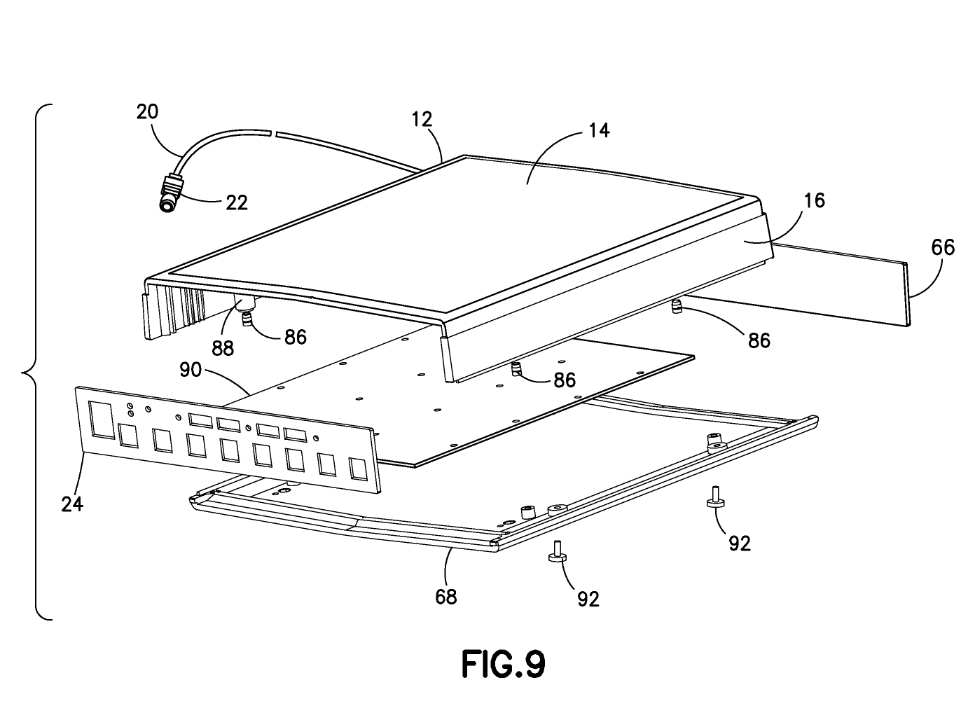

FIG. 9 is an exploded front perspective view of the multi-voltage extended operation DC power supply module 10 of FIGS. 1-8, showing the details of construction thereof. All parts and components are numbered correspondingly in FIG. 9 with respect to the same parts components in FIGS. 1-8, except that the assembly screws 78, 80, 82, and 84 shown in FIG. 6 are identified by reference number 92 in FIG. 9. As illustrated, brass inserts 86 may be disposed in corresponding collars 88 within the housing, to assist in proper registration of the housing cover and panel components, and positioning of the command module printed circuit board 90. The printed circuit board 90 is shown schematically, and comprises circuitry as described more fully hereinafter.

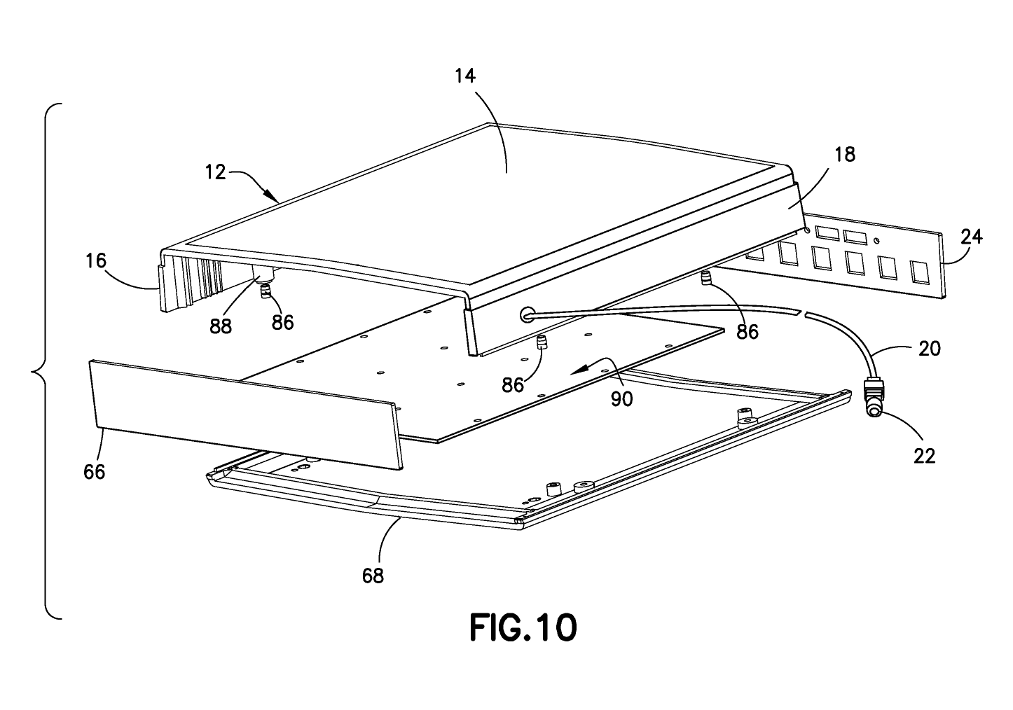

FIG. 10 is an exploded rear perspective view of the multi-voltage extended operation DC power supply module of FIGS. 1-8, showing the details of construction thereof, and correspondingly numbered with respect to the preceding drawings. The DC input cable 20 may comprise a 16/2 stranded cable of suitable length, and the coupling 22 may comprise a 2.1 mm×5.5 mm female CCTV power jack adapter. The DC input cable 20 may enter the sidewall 18 of the housing through an opening in which the cable is circumscribed by a 16/2 stress relief grommet.

The DC power supply module thus may be fabricated as a molded plastic four-piece enclosure with main board and mechanical mounting means, and cabling for routing status signal voltages to indicator LEDs.

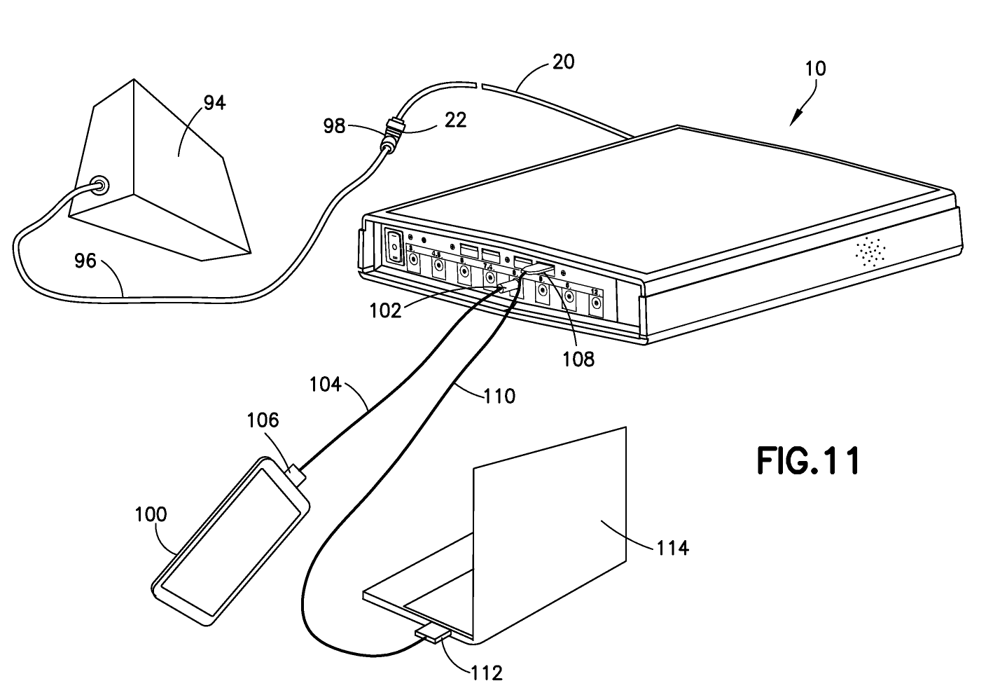

FIG. 11 is a front perspective view of a multi-voltage extended operation DC power supply system according to one embodiment of the present disclosure, comprising a multi-voltage extended operation DC power supply module 10 of a type as shown in FIGS. 1-10, operatively coupled to an energy source assembly 94 by the DC input cable 20 and coupling 22 interconnected with a matably engageable coupling 98 at the terminal end of the energy source assembly cable 96. The energy source assembly 94 may be of any suitable type, and may comprise a solar energy supply assembly, wind energy supply assembly, battery energy source, geothermal energy supply assembly, or other energy supply assembly.

The multi-voltage extended operation DC power supply system is operatively coupled to electrically powered devices receiving power from the DC power supply module. A cell phone 100 is coupled to the DC power supply module 10 by a charging cord 104 including a male plug 102 matably engageable with one of the output power ports of the module at one end, and coupled by connector 106 at the opposite end of the charging cord, to the cell phone. A notebook personal computer 114 is coupled to module 10 by the charging cord 110 having a USB connector at one end thereof that is inserted in a USB port of the module, and having a power adapter connector 112 coupled with a charging port of the notebook personal computer.

As previously indicated, the DC power supply module (see FIG. 3) comprises a series of multi-voltage female ports 28, 30, 32, 34, 36, 38, 40, and 42. Each of these ports may be color-coded, such as by a circumscribing ring of a specific color different from the colors of other ports on their respective circumscribing rings of color. These colors may correspond to the colors of respective charging cords, so that a specific charging cord is utilized in a same-colored voltage port of the DC power supply module. The DC power supply module therefore may be furnished in a kit including a set of charging cords that are color-coded to the respective multi-voltage female ports of the module.

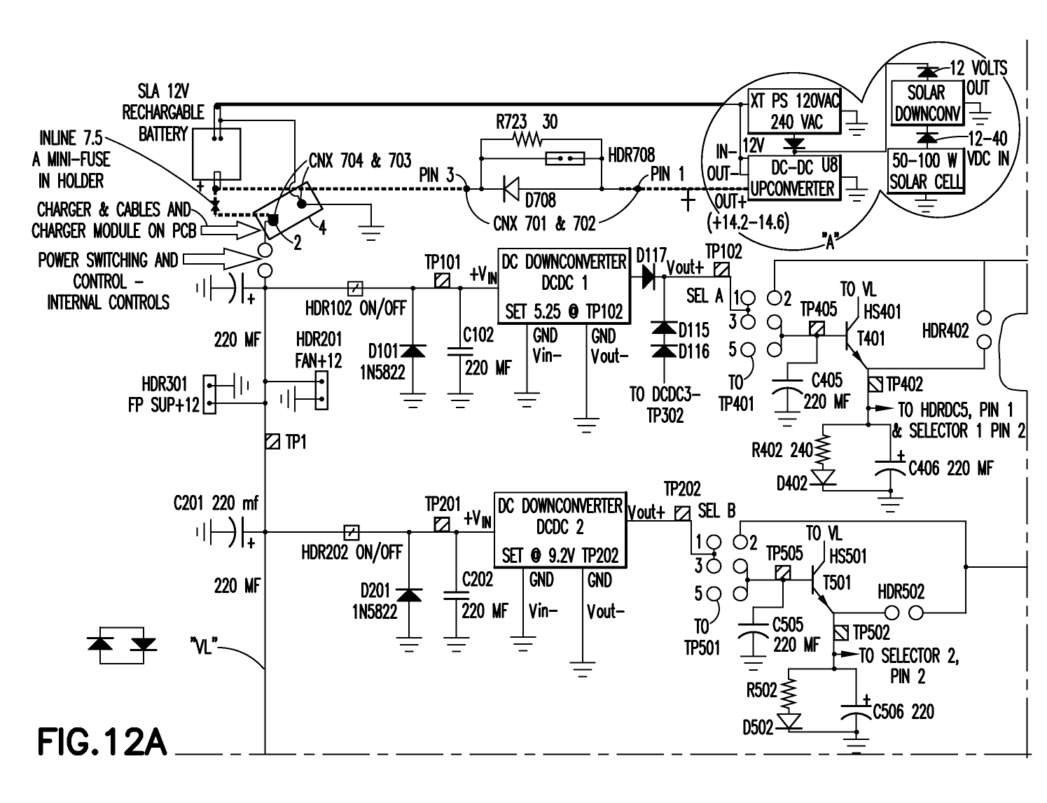

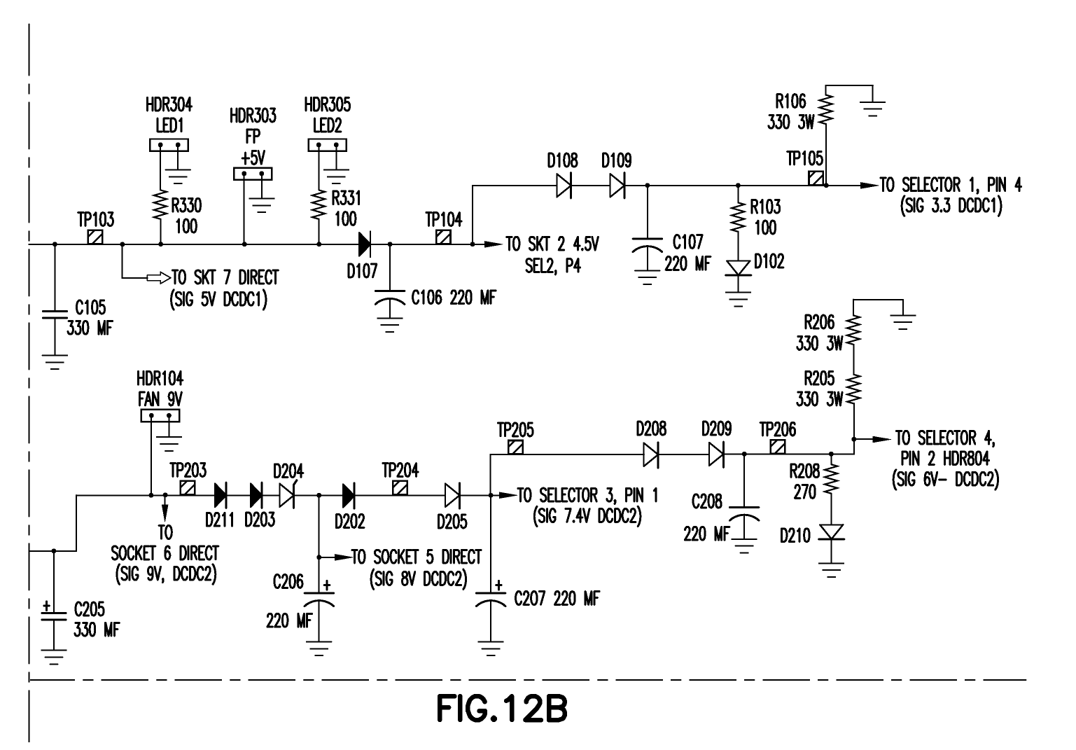

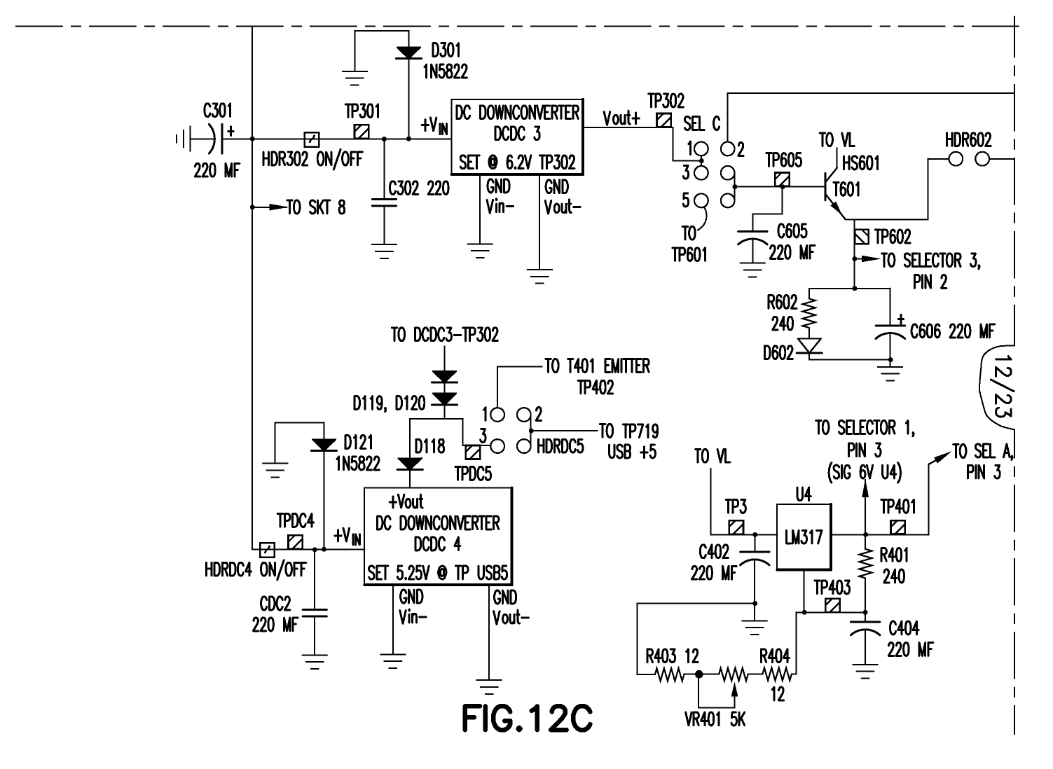

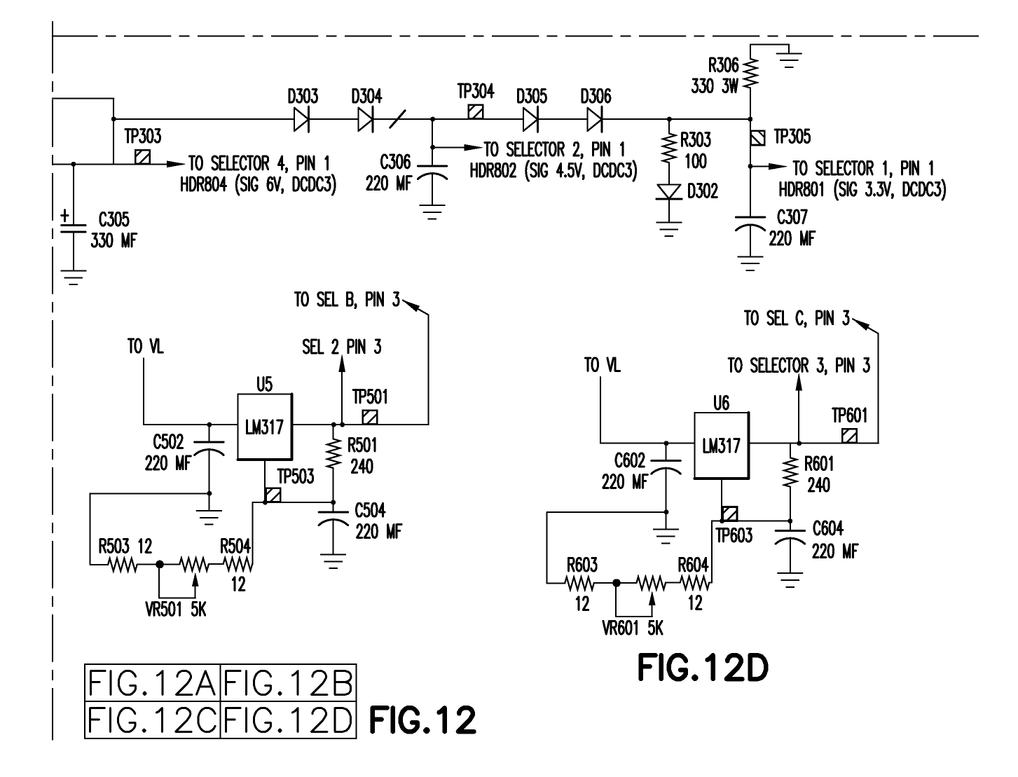

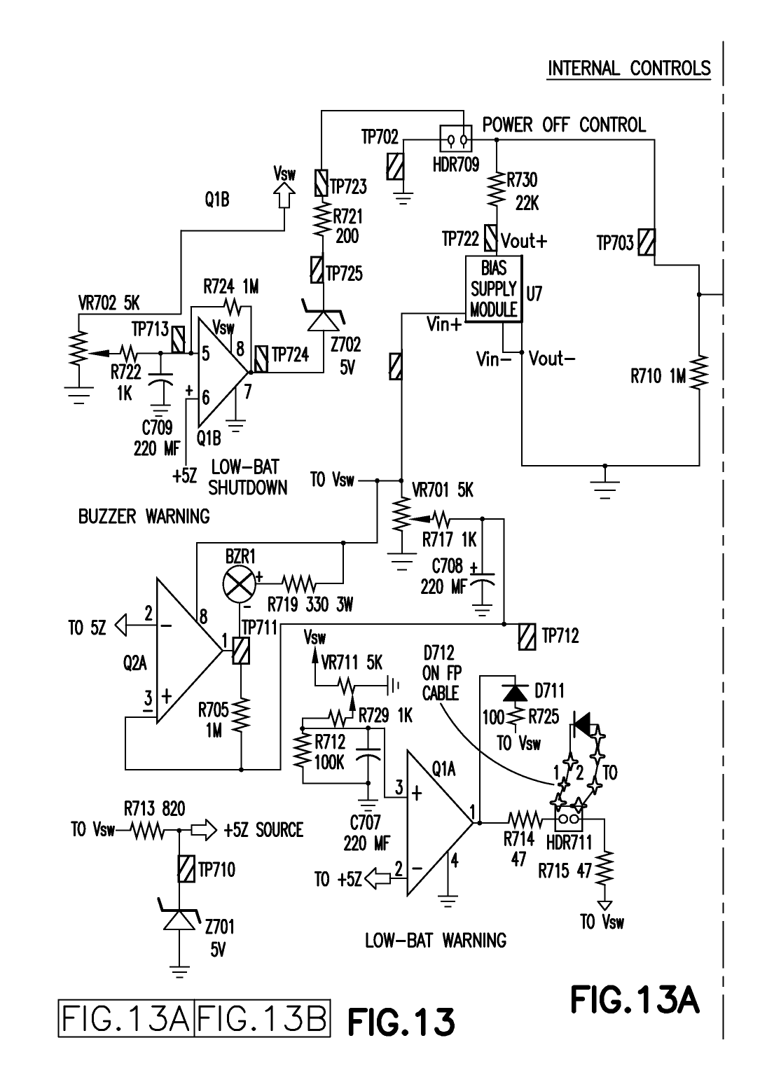

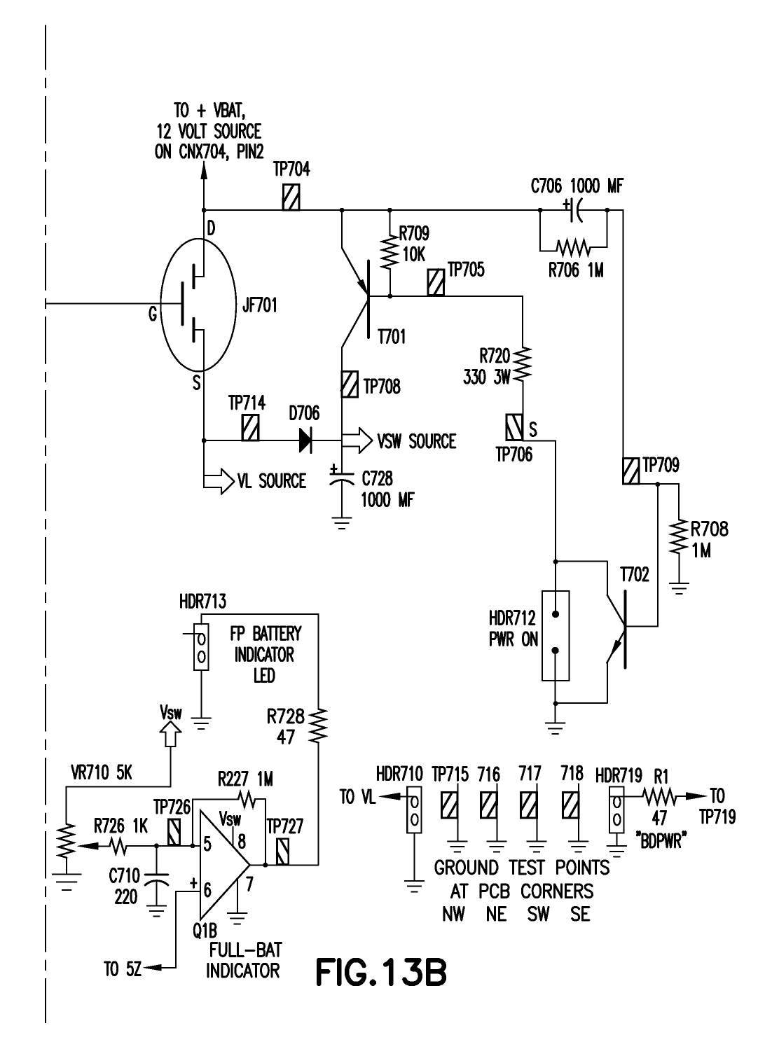

FIG. 12, comprising FIGS. 12A, 12B, 12C, and 12D, is a schematic circuit diagram for the electrical circuitry of the multi-voltage extended operation DC power supply system, according to one embodiment of the disclosure.

In the upper left-hand corner of FIG. 12, the master control circuit board includes a 12 V sealed lead acid (SLA) rechargeable battery. As illustrated, the battery is connected through a line 7.5 amp mini-fuse to the charger and cables and charger module on the printed circuit board and the power switching and control subassembly to the DC input power rail on the main board (line “VL”). The battery is coupled with an input power conditioning assembly including the circuitry associated with the nodes for Pins 1 and 3, as well as an AC-to-DC converter, and an external solar cell (50-100 W) providing 12-40 V DC via the intervening diode to the solar downconverter and diode to provide a 32 V output to the AC-to-DC converter. As indicated, the external power source can be of various types, including the solar cell illustratively depicted, or alternatively any other external power source of appropriate modality.

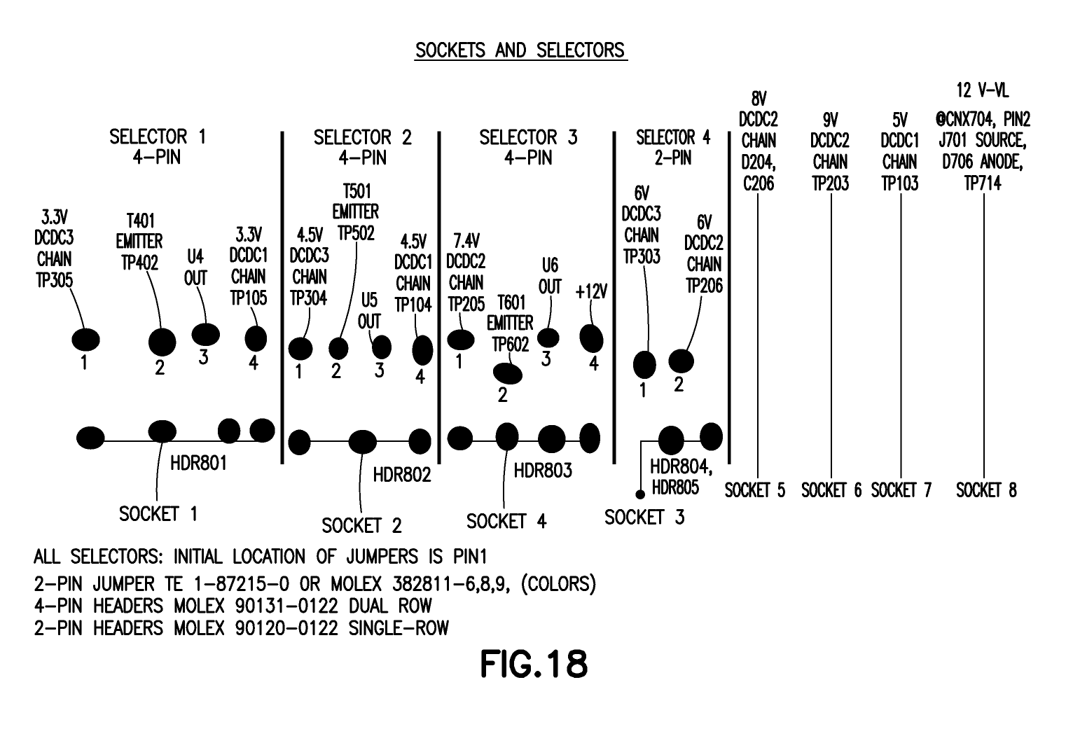

The DC input power rail has junctions with header lines to respective DC downconverter circuits, including (i) a first downconverter circuit coupled to Selector 1 Pin 2, Selector 1 Pin 4, and Selector 2 Pin 4, as well as to Sockets 2 and 7 associated with ports 30 and 40, respectively, (ii) a second downcoverter circuit coupled to Selector 2 Pin 2, Selector 3 Pin 1, Selector 2 Pin 1, and Selector 4 Pin 2, as well as to Sockets 5 and 6 associated with ports 36 and 38, respectively, (iii) a third downconverter circuit coupled to Selector 3 Pin 2, Selector 4 Pin 1, and Selector 1 Pin 1. A fourth downconverter circuit is connected to the DC input power rail at the lower left-hand portion of the circuit diagram of FIG. 12. Further circuits connected to the DC input power rail are shown to the right of such fourth downconverter circuit at the bottom portion of FIG. 12. Such additional circuits include (a) a first circuit connected to Selector 1 Pin 3 and Selector A Pin 3, (b) a second circuit connected to Selector 2 Pin 3 and Selector B Pin 3, and (c) a third circuit connected to Selector 3 Pin 3 and Selector C Pin 3. The relationship between the sockets and selectors on the one hand, and the connector ports 26, 28, 30, 32, 34, 36, 38, 40, and 42 on the other hand, is more fully described hereinafter, in connection with FIG. 18 hereof.

FIG. 13, comprising FIGS. 13A and 13B, is a schematic circuit diagram for the electrical circuitry for internal controls in the multi-voltage extended operation DC power supply system. The circuitry includes a low-battery shutdown circuit including the operational amplifier and senior diode circuit at the upper left-hand portion of the internal controls circuit coupled with the bias supply module in the power off control circuit. The bias supply module as shown is connected to a buzzer warning circuit including an indicator lamp coupled with the operational amplifier, in the lower left-hand portion of the drawing. A low battery warning circuit is provided, as is a full battery indicator circuit includes a battery indicator LED. The power off control circuit is coupled to a field effect transistor and power on components, as illustrated.

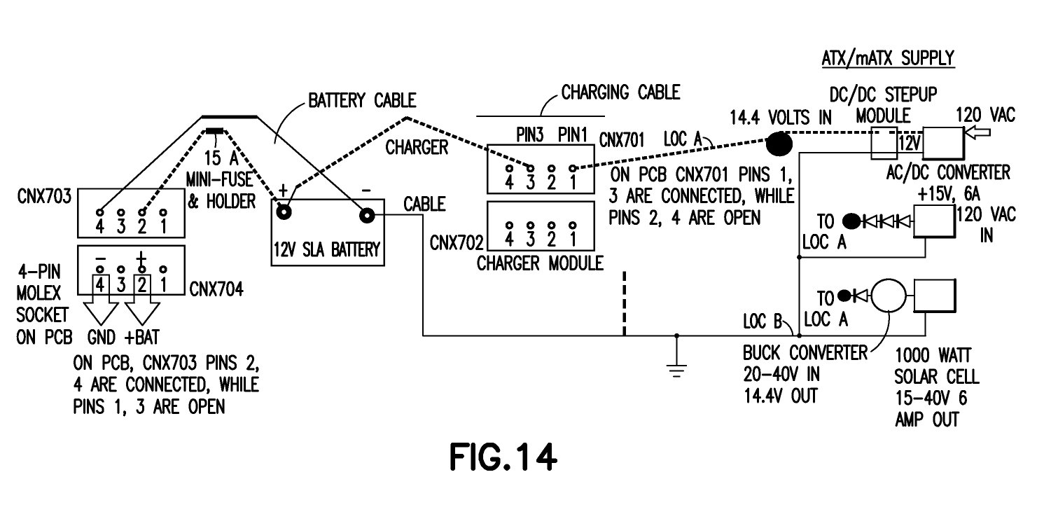

FIG. 14 is a schematic diagram of a battery energy input source assembly coupled by a cable arrangement with the multi-voltage extended operation DC power supply module. A 4-pin Molex socket is provided on the printed circuit board, with pins 2 and 4 being connected and pins 1 and 3 being open. The battery cable from pin 2 connects to the positive terminal of the 12 V sealed lead acid battery, and includes a 15 amp mini-fuse and holder. The battery cable from pin for connects to the negative terminal of the sealed lead acid battery. The battery cables in a specific embodiment may be on the order of 15 inches in length.

In the battery energy source assembly, a charger module is provided in which pins 1 and 3 are connected, while pins 2 and 4 are open. Pin 3 is connected to the positive terminal of the sealed lead acid battery by a corresponding charging cable, and pin 1 is connected to a DC/DC StepUp Module in the input section of the assembly, which in turn is coupled to an AC/DC converter on an ATX/mATX board. The AC/DC converter is configured to receive AC input from an AC supply source (not shown) as an external energy supply for charging the sealed lead acid battery. The input section may also include a series arrangement of diodes in a diode bridge configuration as a bridge rectifier for conversion of an AC input to a DC output. The input section may further include a solar cell, e.g., a 100 W solar cell providing 15-40 V, 6 amp output that is coupled to a buck converter configured to provide smaller voltage DC output, e.g., a 14.4 V DC output when receiving a 20-40 DC voltage input. The input section is coupled by a cable connection to the negative terminal of the sealed lead acid battery.

It will be appreciated that a variety of switching regulators can be used in the input section of the battery energy source assembly, including buck converters and boost converters of varied type, as appropriate to the specific energy input in the battery energy source assembly, and that a variety of source energy types, including direct current energy, alternating current energy, photonic energy, and any other suitable energy type, can be employed for charging of the battery in the DC power supply apparatus of the disclosure, in various embodiments thereof.

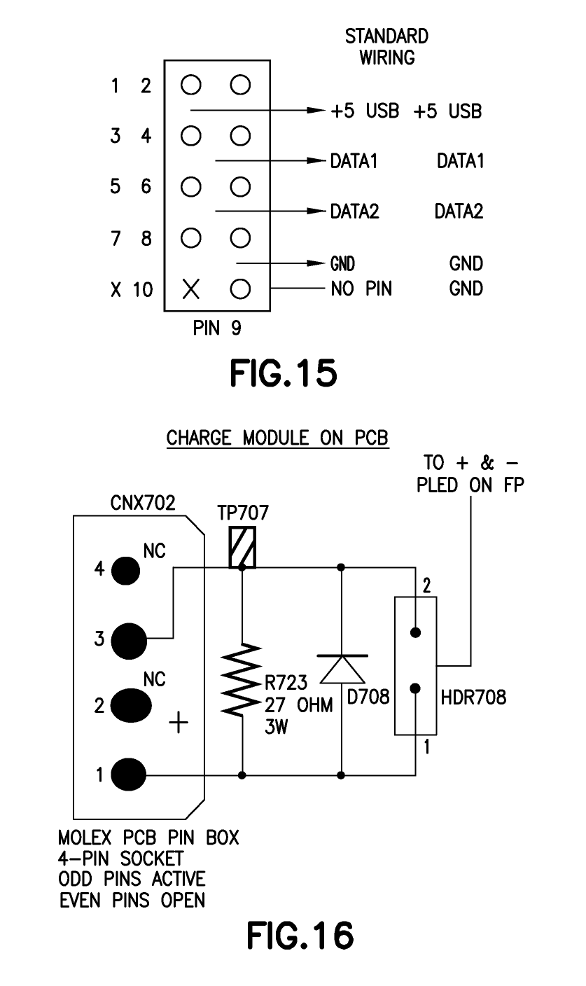

FIG. 15 is a schematic representation of a USB header of the multi-voltage extended operation DC power supply module, showing data, ground, and USB connections, in an illustrative embodiment.

FIG. 16 is a schematic diagram of the electrical circuitry for the charge module on the printed circuit board of the multi-voltage extended operation DC power supply module, according to one embodiment. A 4 pin socket Molex printed circuit board pin box is shown in which the odd-numbered pins are active and the even-numbered pins are open. As illustrated, the active pins are connected by a resistor-diode parallel circuit to corresponding connections for an LED on the front panel of the DC power supply module.

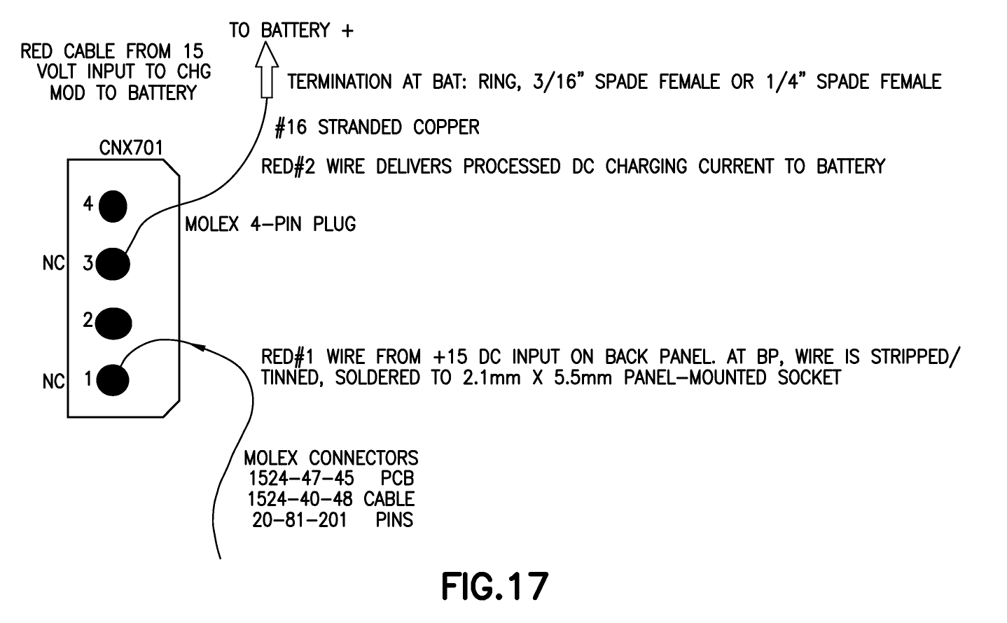

FIG. 17 is a schematic diagram of the charge module connection to the battery energy input source assembly. A Molex 4 pin box is depicted in which a wire connector, e.g., of stranded copper, interconnects pin 3 of the pen box with the positive terminal of the battery of the extended operation DC power supply module. The wire includes a plug for engagement of pin 3 and at its opposite end may include a ring connector, 3/16 inch spade female connector, or ¼ inch spade female connector, for connection with the positive terminal of the battery, to deliver processed DC charging current to the battery. The pin 1 wire connected to the pin box is joined at its opposite end to a 15 V DC input socket on the back panel of the DC power supply module housing.

FIG. 18 is a schematic representation of the sockets and selectors of the multi-voltage extended operation DC power supply system, as arranged for providing selected voltage outputs from the DC power supply module, according to one embodiment of the disclosure. The sockets and selectors array include a 4 pin Selector 1, a 4 pin Selector 2, a 4 pin Selector 3, and a 2 pin Selector 4, which are associated with Socket 1, Socket 2, Socket 4, and Socket 3, respectively. In all Selectors, a corresponding header (“HDR”) is schematically illustrated, and the initial location of the jumpers in each of the Selectors is Pin 1.

Selector 1 as shown is configured to provide a 3.3 V output to Socket 1 comprised in the DC output voltage port 28 of the DC power supply module (see FIGS. 1 and 3).

Selector 2 is configured to provide a 4.5 V output to Socket 2 comprised in the DC output voltage port 30 of the DC power supply module (see FIGS. 1 and 3).

Selector 3 is configured to provide a 7.4 V output to Socket 4 comprised in the DC output voltage port 34 of the DC power supply module (see FIGS. 1 and 3). Selector 3 may also be configured to alternatively provide a 12 V output.

Selector 4 is configured to provide a 6 V output to Socket 3 comprised in the DC output voltage port 32 of the DC power supply module (see FIGS. 1 and 3).

Socket 5, as comprised in the DC output voltage port 36 of the DC power supply module, is configured to provide an 8 V output. Socket 6, as comprised in the DC output voltage port 38 of the DC power supply module, is configured to provide a 9 V output. Socket 7, as comprised in the DC output voltage port 40 of the DC power supply module, is configured to provide a 5 V output. Socket 8, as comprised in the DC output voltage port 42 of the DC power supply module, is configured to provide a 12 V output. See FIGS. 1 and 3.

It will be appreciated that the specific voltages provided by the selector and socket array may be varied in the broad practice of the present disclosure, to provide an appropriate choice of output voltages, as appropriate to a specific desired implementation of the DC power supply module of the present disclosure.

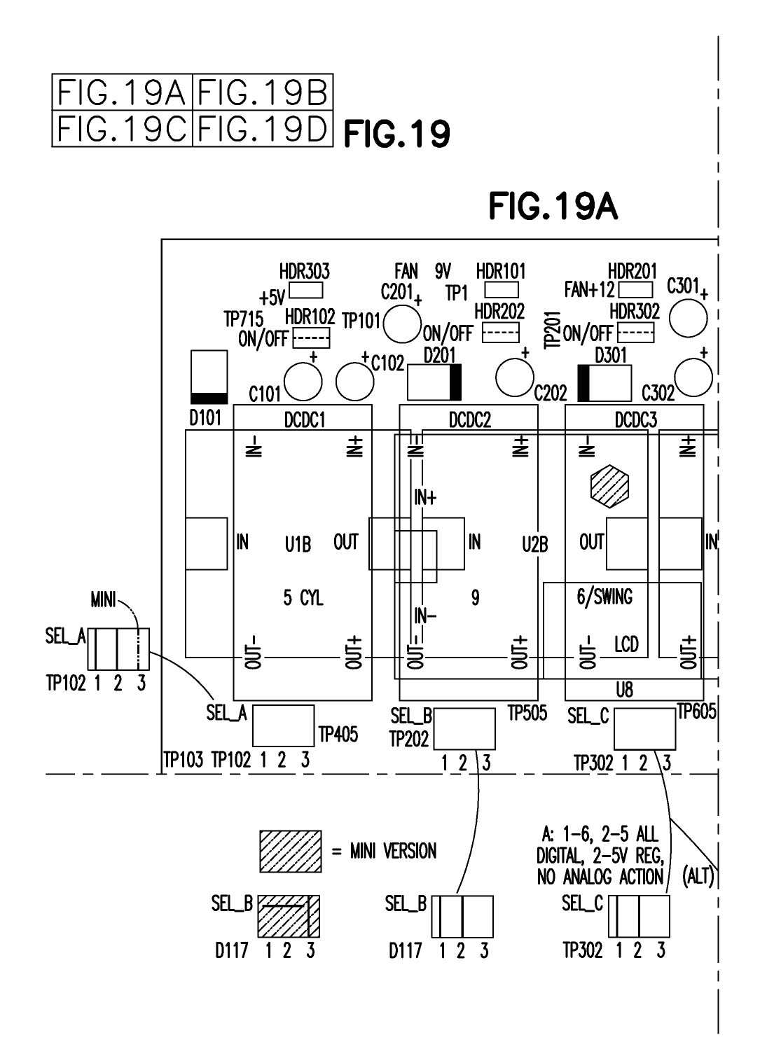

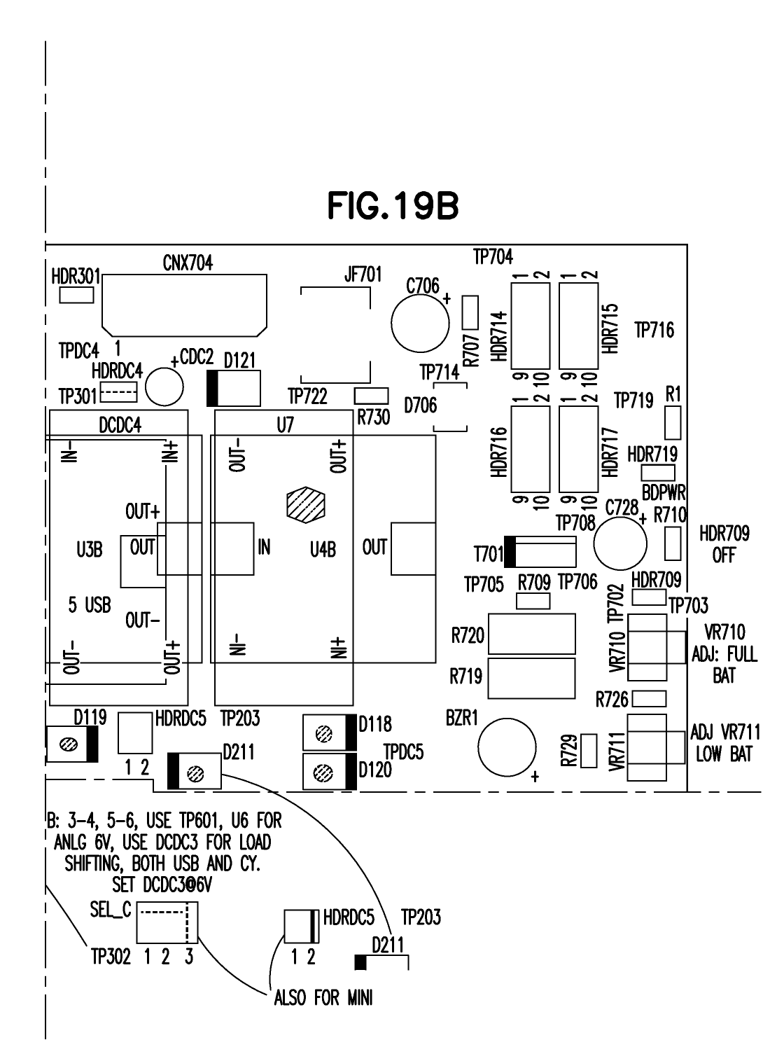

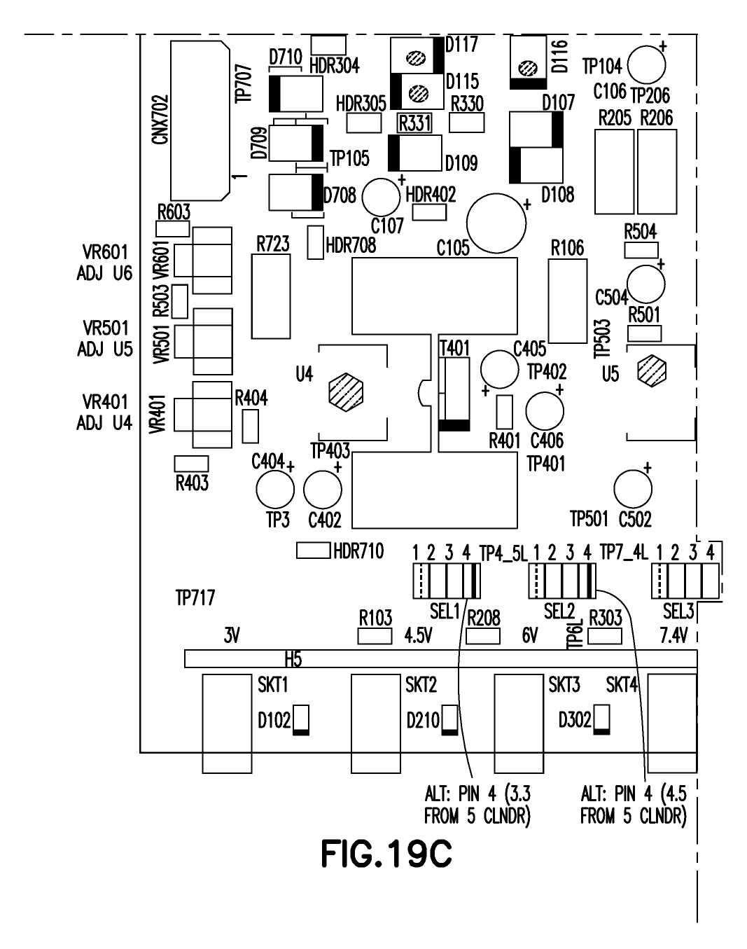

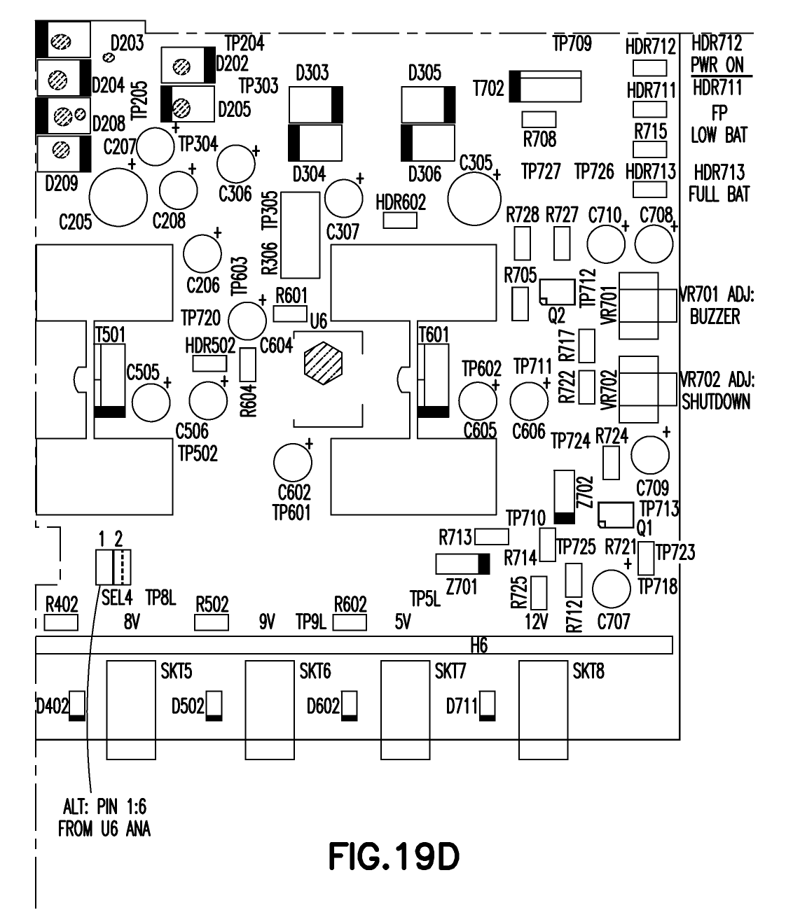

FIG. 19, comprising FIGS. 19A, 19B, 19C, and 19D, is a schematic representation of the printed circuit board arrangement and components, in a multi-voltage extended operation DC power supply module, according to one embodiment of the disclosure. As illustrated, the arrangement and components for a mini version of the full version arrangement is also indicated in the FIG. 19 schematic representation of the printed circuit board arrangement and components. The circuit board is arranged to provide the previously described selected voltages of 3 V, 4.5 V, 6 V, 7.4 V, 8 V, 9 V, 5 V, and 12 V at the respective voltage ports on the front panel of the DC power supply module, as well as the USB ports on such front panel, together with the power on/power off, low battery, full battery, buzzer, and shutdown functions described hereinabove.

As is evident from the accompanying drawings and preceding disclosure, the multi-voltage direct current uninterruptible power supply apparatus of the present disclosure achieves an efficient and compact configuration in which a battery or other energy storage device can be supplied with energy for storage from a wide variety of energy sources and modalities, to provide long-cycle multi-simultaneous and continuous direct-current power to multiple devices for charging and/or operation thereof. The long-cycle duration of power supply to served electrical/electronic devices such as cell phones, tablets, notebook and desktop computers can be on the order of days to weeks up to months, to accommodate extended duration local power mains outages, such as those occurring as a result of natural disaster events, local mains electrical grid sabotage, electrical grid breakdown as a result of component failures, etc.

It therefore is evident that the multi-simultaneous and continuous voltage DC-UPS apparatus of the present disclosure provides a fundamental advance in the power management art over conventional AC-UPS and DC-UPS technologies, in the provision of a compact, readily fabricated, efficient modular system that can maintain the operational capability of digital electronic accessories and other electrical appliances during short-term as well as long-term power outage events.

While the disclosure has been set forth herein in reference to specific aspects, features and illustrative embodiments, it will be appreciated that the utility of the disclosure is not thus limited, but rather extends to and encompasses numerous other variations, modifications and alternative embodiments, as will suggest themselves to those of ordinary skill in the field of the present disclosure, based on the description herein. Correspondingly, the disclosure as hereinafter claimed is intended to be broadly construed and interpreted, as including all such variations, modifications and alternative embodiments, within its spirit and scope.

What is claimed is:

1. A multi-voltage direct current uninterruptable power supply, comprising:
an input power conditioner assembly comprising an AC-to-DC converter adapted to receive power continuously from an AC power source and responsively generate a DC output;
a rechargeable battery arranged to receive the DC output of the input power conditioning assembly, and to provide continuous output power;
a power management assembly comprising:
a power management circuit arranged to receive output power from the rechargeable battery, the power management circuit comprising a line fuse, a field effect transistor switch, and a DC input power rail, arranged so that when the field effect transistor switch is actuated, power is delivered continuously from the rechargeable battery through the line fuse and field effect transistor switch of the power management circuit to the DC input power rail at a rate correlative to aggregate load on the rail, the power management circuit further comprising a boost regulator coupled with the field effect transistor switch, with a current-limiting resistor therebetween;
a power-on switch actuatable to generate an initiating output signal for transmission in the power management circuit to the boost regulator, with the boost regulator being responsive to the initiating output signal to transmit a positive bias voltage in the power management circuit through the current-limiting resistor to the field effect transistor switch so that the field effect transistor switch is actuated to enable power delivery from the rechargeable battery through the line fuse to the DC input power rail, and to provide a latch for the positive bias voltage to the field effect transistor switch; and
a momentary switch actuatable to ground the positive bias voltage and thereby deactuate the field effect transistor switch and terminate power delivery from the rechargeable battery through the line fuse to the DC input power rail.

2. The multi-voltage direct current uninterruptable power supply of claim 1, comprising monitoring circuitry that is operative to provide at least one of (i) output indicative of state of charge of the rechargeable battery, (ii) actuation of the momentary switch for shutdown of the multi-voltage direct current uninterruptable power supply corresponding to a predetermined state of charge condition of the rechargeable battery, and (iii) output indicative of an approaching state of charge condition for actuation of the momentary switch for shutdown of the multi-voltage direct current uninterruptable power supply.

3. The multi-voltage direct current uninterruptable power supply of claim 2, wherein the monitoring circuitry comprises a visual output display.

4. The multi-voltage direct current uninterruptable power supply of claim 3, wherein the visual output display comprises an LED output display.

5. The multi-voltage direct current uninterruptable power supply of claim 2, wherein the monitoring circuitry comprises an audible alarm.

6. The multi-voltage direct current uninterruptible power supply of claim 1, comprising monitoring circuitry that is configured to monitor the rechargeable battery and to provide an output indicative of battery charge.

7. The multi-voltage direct current uninterruptible power supply of claim 6, wherein said monitoring circuitry comprises at least one LED that is actuated to provide said output indicative of battery charge.

8. The multi-voltage direct current uninterruptible power supply of claim 7, wherein said at least one LED comprises a first LED that is actuated to provide a low battery charge indication.

9. The multi-voltage direct current uninterruptible power supply of claim 8, wherein said at least one LED comprises a second LED that is actuated to provide a full battery charge indication.

10. The multi-voltage direct current uninterruptible power supply of claim 1, comprising monitoring circuitry that is configured to monitor the rechargeable battery and to provide an output indicative of imminent shutdown due to depletion of battery charge of the rechargeable battery.

11. The multi-voltage direct current uninterruptible power supply of claim 10, wherein said output comprises an acoustic output.

12. The multi-voltage direct current uninterruptible power supply of claim 10, wherein said output comprises a visual output.

13. The multi-voltage direct current uninterruptible power supply of claim 1, comprising monitoring circuitry that is configured to terminate operation of the power supply when battery charge has declined to a predetermined charge level.

14. The multi-voltage direct current uninterruptible power supply of claim 1, comprising:
a plurality of DC power delivery circuits coupled to the DC input power rail and configured to provide DC output power; and
at least one DC power output port coupled to each of the plurality of DC power delivery circuits.

15. The multi-voltage direct current uninterruptible power supply of claim 14, wherein each DC power output port is configured to provide a DC power output at a voltage that is different from at least one other DC power output port.

16. The multi-voltage direct current uninterruptible power supply of claim 14, wherein each DC power output port is configured to provide a different DC power output.

17. The multi-voltage direct current uninterruptible power supply of claim 14, comprising at least six DC power output ports.

18. The multi-voltage direct current uninterruptible power supply of claim 17, wherein said DC power output ports comprise at least one USB port.

19. The multi-voltage direct current uninterruptible power supply of claim 17, wherein said DC power output ports comprise multiple USB ports.

20. The multi-voltage direct current uninterruptible power supply of claim 1, comprising one or more buck DC-DC converters, each configured to receive DC power from the DC input power rail through a selector switch and to deliver a reduced voltage output to a second selector switch bank for routing to deliver DC output power.

21. The multi-voltage direct current uninterruptible power supply of claim 1, comprising one or more buck DC-DC converters, each of which is connected to a routing switch bank and steering diodes to deliver DC output power.

22. The multi-voltage direct current uninterruptible power supply of claim 1, comprising multiple buck DC-DC converters connected to circuitry defining a plurality of DC output power routes, wherein each of the multiple buck DC-DC converters is adjustable and wherein the circuitry is configured to operatively adjust the multiple buck DC-DC converters or a selected one or ones thereof to provide predetermined current(s) to a selected one or ones of the plurality of DC output power routes.

23. The multi-voltage direct current uninterruptible power supply of claim 1, comprising adjustable analog buck DC-DC converters connected via selector switches to provide a selectable and routable DC output power.

24. The multi-voltage direct current uninterruptible power supply of claim 1, comprising first and second switch banks, wherein the second switch bank receives power from the first switch bank and is configured to enable selection of specific ones of multiple routes for delivery of DC output power to specific ones of multiple DC output power ports.

25. The multi-voltage direct current uninterruptible power supply of claim 1, comprising one or more USB sockets configured to deliver charging and powering DC output power.

26. The multi-voltage direct current uninterruptible power supply of claim 1, comprising circuitry coupled to the DC input power rail and to multiple cylindrical sockets, wherein the circuitry is configured to deliver differing DC output voltages to at least some of the multiple cylindrical sockets.

27. The multi-voltage direct current uninterruptible power supply of claim 26, wherein the circuitry is configured to deliver a different DC output voltage to each of the multiple cylindrical sockets.

28. The multi-voltage direct current uninterruptible power supply of claim 26, wherein each of the multiple cylindrical sockets is color-coded to specify the differing DC output voltages thereof.

29. The multi-voltage direct current uninterruptible power supply of claim 28, comprising DC output power delivery cables configured to be coupled with corresponding ones of the multiple cylindrical sockets, and color-coded in correspondence thereto.

30. The multi-voltage direct current uninterruptible power supply of claim 1, wherein the power management circuit is provided on a main printed circuit board that is mounted in a housing enclosure comprising a panel including DC output power ports that are coupled with the power management circuit and supply different voltages of DC output power.

31. A direct current uninterruptible power supply apparatus, comprising power input circuitry for receiving power effective for charging a rechargeable battery, a rechargeable battery coupled with said power input circuitry for charging thereof, a DC input power rail coupled with the rechargeable battery, and DC output power circuitry coupled with the DC input power rail and with multiple DC power output ports, said DC output power circuitry comprising a plurality of buck DC-DC converters and routing switches configured to deliver DC output power at different voltages to at least some of the multiple DC power output ports, and configured to vary currents of the DC output power delivered to the multiple DC power output ports in response to charging or operating loads of devices coupled thereto, to thereby effect load sharing between the ones of the multiple DC power output ports to which devices are coupled.

32. The direct current uninterruptible power supply apparatus of claim 31, wherein the power input circuitry comprises an AC-to-DC converter to accommodate AC power input to the apparatus from an external AC source.

33. The direct current uninterruptible power supply apparatus of claim 31, comprising monitoring circuitry configured to monitor the charge state of the rechargeable battery and to generate an output correlative of the charge state.

34. The direct current uninterruptible power supply apparatus of claim 33, wherein the monitoring circuitry comprises at least one of an acoustic output device and a visual output device for transmitting set output correlative of the charge state.

35. The direct current uninterruptible power supply apparatus of claim 34, wherein the monitoring circuitry comprises at least one LED visual output device.

36. The direct current uninterruptible power supply apparatus of claim 31, wherein the multiple DC power output ports are color-coded to DC output power voltages delivered by such ports.

37. The direct current uninterruptible power supply apparatus of claim 36, in combination with multiple DC power delivery cables that are color-coded to the DC power output ports to which they are intended to be coupled.

38. The direct current uninterruptible power supply apparatus of claim 31, wherein the rechargeable battery comprises a sealed lead acid battery.

39. The direct current uninterruptible power supply apparatus of claim 31, wherein the multiple DC power output ports comprise one or more USB ports.

40. The direct current uninterruptible power supply apparatus of claim 31, wherein the multiple DC power output ports comprise USB and non-USB ports.

41. The direct current uninterruptible power supply apparatus of claim 31, in combination with multiple electronic devices each coupled to a separate one of the multiple DC power output ports.

42. A method of maintaining continued operational viability of at least one electrically powered device during a local electrical network outage, said method comprising transmitting charging and/or operating power to the at least one electrically powered device while coupled to:
(i) the multi-voltage direct current uninterruptible power supply of claim 1, or
(ii) a direct current uninterruptible power supply apparatus, comprising power input circuitry for receiving power effective for charging a rechargeable battery, a rechargeable battery coupled with said power input circuitry for charging thereof, a DC input power rail coupled with the rechargeable battery, and DC output power circuitry coupled with the DC input power rail and with multiple DC power output ports, said DC output power circuitry comprising a plurality of buck DC-DC converters and routing switches configured to deliver DC output power at different voltages to at least some of the multiple DC power output ports, and configured to vary currents of the DC output power delivered to the multiple DC power output ports in response to charging or operating loads of devices coupled thereto, to thereby effect load sharing between the ones of the multiple DC power output ports to said at least one electrically powered device is coupled.
